(19) United States
(12) Patent Application Publication
(10) Pub. No.: US 2007/0261736 A1
(43) Pub. Date: Nov. 15, 2007

(54) Valve Device for and a Method of Controlling Fluid Flow

(75) Inventors: Kalle Larsson, Helsingborg (SE); Lars Aksel Thingelstad, Drammen (NO)

Correspondence Address: CALFEE HALTER & GRISWOLD, LLP, 800 SUPERIOR AVENUE, SUITE 1400, CLEVELAND, OH, 44114, US

(73) Assignee: Elopak Systems AG, Glattbrugg (CH)

(21) Appl. No.: 10/576,275

(22) PCT Filed: Oct. 22, 2004
(86) PCT No.: PCT/IB04/03478

§ 371 Date: Mar. 23, 2007

(30) Foreign Application Priority Data
Oct. 22, 2003 (GB) 0324717.8

(51) Int. Cl. F16K 31/06

(52) U.S. Cl. 137/315.03

(57) ABSTRACT

A valve device (4) for controlling fluid flow comprises a hollow body (2) bounding a flow path through the valve device (4), a valve obturating member (10) in the flow path and movable between a fully obturating position and a less obturating position for permitting lesser and greater flows of fluid along the path, which flows urge the member (10) in the sense from the more obturating position to the less obturating position, the valve obturating member (10) including magnetic portions (18), and at least one electrically energizable inductor (22) fixed relative to the body (2) and serving to act upon the valve obturating member (10) to urge the valve obturating member (10) in the sense from the less obturating position to the fully obturating position.

This invention relates to a valve device for and a method of controlling fluid flow.

It is conventional to use a spring to urge a valve closure member of a valve device into a closed position against the pressure of fluid the flow of which is controlled by the device, as disclosed in, for example, EP-A-90664. With such a valve device, to adjust the extent of opening of the valve closure member to the character of the liquid, the pumping rate of a pump supplying the liquid to the valve device may be adjusted. However, if the pumping rate required is relatively low, the spring causes the valve closure member to be almost closed, so that the liquid is expelled laterally outwards, thus creating undesired splashing of the liquid onto the inside wall of the mouth of the container, whereas, if the pumping rate required is relatively high, the spring causes the member to be virtually fully open, so that the liquid is expelled almost vertically downwards, thus promoting undesired foaming of the liquid in the container.

It is also known from, for example, EP-A-329,287 and EP-A-1,316,750, to use an inductor to displace a valve closure member against the action of a spring to open the member.

EP-A-329,287 discloses a liquid packaging machine which includes a filler containing a non-return valve device spring-biased closed. The valve device includes a closure member to a stem of which is fixed a centering spider, the spokes of which contain iron members. Distributed around the valve housing are inductors in the form of horseshoe, permanent magnets. During production of filled cartons, the magnet device is positioned so as not to interfere with the movement of the closure member. However, when air is to be bled from the filler and/or the filler is to be steam-sterilized, the magnet device is positioned to attract the iron members to open the valve device against the spring bias.

EP-A-1,316,750 discloses a small-sized and low-cost proportional solenoid valve capable of controlling bidirectional fluid flows. The valve includes a core fixed in a pipe and, axially fixed in the core, a hollow shaft defining a valve seat and having valve holes. A hollow cylindrical valve closure member is axially movable and uses the shaft as a guide. The closure member is actuated by a plunger and by a spring, to open and close, respectively, the valve holes. Outside the pipe an inductor in the form of a solenoid coil is provided for driving the plunger. The valve component parts are arranged within the pipe. The operation of the hollow cylindrical valve closure member is not adversely affected by the direction of the fluid flow. This allows controlling of bidirectional fluid flows.

It is further known to use an inductor instead of a closing spring, as in EP-A-1,277,694, which discloses a dispenser device for fluid substances which comprises a tubular body with an opening for the infeed of the fluid substances and a dispenser outlet. Inside the tubular body there is a plug for closing and opening the outlet. The plug is lifted from a lowered position in which it closes the outlet into a raised position in which it frees the outlet, allowing the fluid substances to be dispensed, by an inductor on the external surface of the tubular body able to generate a magnetic field in the tubular body which magnetises and moves the plug relative to the tubular body. The plug falls to its closing position under gravity when a control and adjustment unit interrupts the electrical power supply to the inductor.

US-A-2002/0177237 discloses a dispenser for liquid droplets of the order of 30 μl or less in volume. The dispenser comprises a metering valve body having a main bore connected by a pipe to a pressurised liquid delivery source. The body comprises a base in which is mounted a nozzle projecting above the base to form a valve seat. An actuating coil assembly is mounted on the exterior of the body for moving a floating valve boss of a ferromagnetic material. Sensing coils are mounted around and spaced-apart along the body and form parts of a valve boss detector. The valve boss detector acts as a positional movement detector so that the opening and closing of the valve can be accurately controlled and bouncing of the valve boss either against an end stop or on the valve seat can be greatly minimized, if not prevented fully, by careful operation of the actuating coil assembly.

According to one aspect of the present invention, there is provided a valve device for controlling fluid flow, comprising
a hollow body bounding a flow path for the fluid through said valve device,
a valve obturating member in said flow path and movable between a more obturating position and a less obturating position for permitting lesser and greater flows of said fluid along said path, which flows urge said member in the sense from said more obturating position to said less obturating position, said valve obturating member including magnetic portions,
an electrically energizable inductor which, while remaining stationary relative to said body and while electrically energized, acts upon said valve obturating member to urge said valve obturating member in the sense from said less obturating position to said more obturating position,
an electrical supply arrangement connected to said inductor, and
a control arrangement which is connected to said electrical supply arrangement and which serves to control the current supplied to said inductor by said supply arrangement.

According to another aspect of the present invention, there is provided a method of controlling fluid flow, comprising producing fluid flow along a flow path in a direction such that said fluid flow urges a valve obturating member in a sense from a more obturating position to a less obturating position, and electrically energizing an inductor, while said inductor remains stationary, to cause said inductor to act inductively upon said valve obturating member to urge said valve obturating member in the sense from said less obturating position to said more obturating position.

Owing to the invention, the valve device can be of very simple construction, with no moving parts other than the valve obturating member itself. Furthermore, if the inductor is an electromagnet or a winding, the force urging the valve obturating member towards its more obturating position can be varied in accordance with a change of use, for example use to control the flow of a different fluid, or even while the valve obturating member is moving.

The more obturating position may be an end position in which the valve obturating member is fully closed on a valve seat, so as to be applied to the seat in a substantially fluid-tight manner.

In order that the invention may be clearly and completely disclosed, reference will now be made, by way of example, to the accompanying drawings, in which:

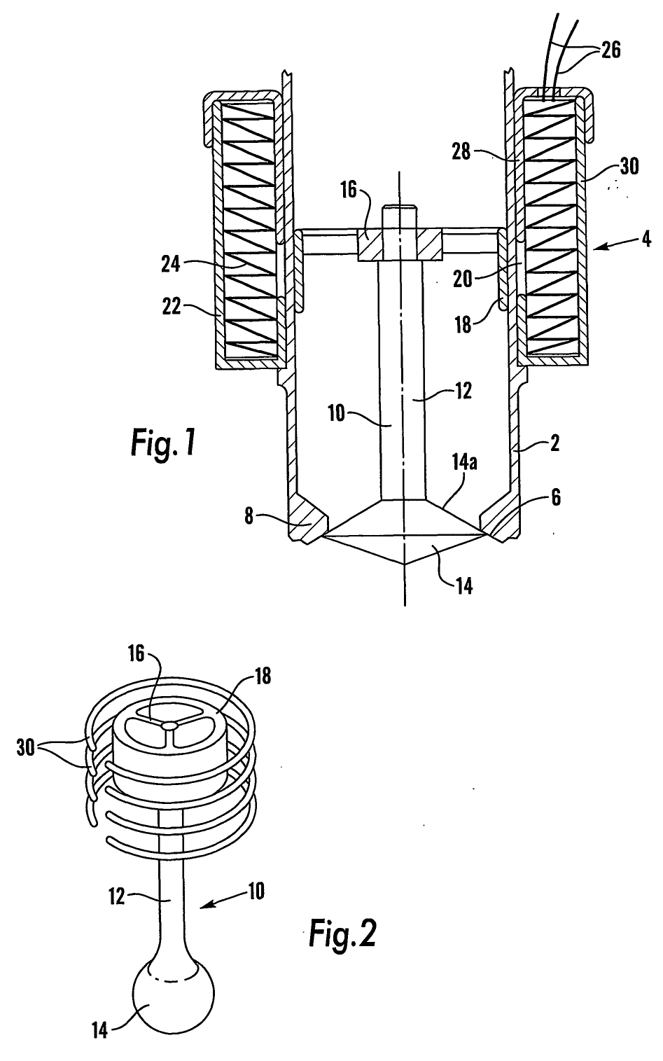

FIG. 1 shows a fragmentary, vertical, axial section through a filler valve device of a filling station of a packaging machine; and

FIG. 2 shows a diagrammatic perspective view of a modified version of the filler valve device.

Referring to FIG. 1, part-way down a filler tube 2 in a form-fill-seal packaging machine is an electromagnetic valve 4. The tube 2 does not need to extend vertically downwards but can be in any desired orientation. The valve 4 controls the flow down the tube 2 of a fluid, in particular a liquid, for example milk or orange juice. At the lower end of the tube 2 is a flexible filler nozzle (not shown). The valve device includes a downwardly-facing, annular, valve seat 6 provided by an annular shoulder 8 formed on the inside of the tube 2. Coaxial with and vertically displaceable in the tube 2 is a valve obturating member 10 of the valve 4, the member 10 including a vertical stem 12 at the lower end of which is formed a valve closure head 14 which, in the illustrated, closed position of the member 10, bears sealingly against the valve seat 6 in a substantially fluid-tight manner. The head 14 has an upper surface 14a which is of frusto-conical form and which directs the liquid downwardly and outwardly. The member 10 includes, at its upper end, a radial spider 16 fixed to the stem 12. At the outer periphery of the spider 16 it includes a guiding ring 18 which guides movement of the member 10 along the tube 2 and which, in the closed position shown, is roughly co-extensive with an annular air gap 20 of an electromagnet 22 which fixedly encircles the tube 2 and which consists of an annular core wound with a coil (both of these items being indicated at 24) electrically supplied via leads 26. The core and coil 24 are enclosed within a pair of annular channels 28 and 30 which overlap at their outer edges and are spaced apart at their inner edges to provide the air gap 20. The tube 2 and the channels 28 and 30 are preferably of non-magnetic material whilst, of the member 10, at least the ring 18 is of magnetic material.

In use of the valve device shown, an electrical current is continuously supplied via the leads 26, so that the electromagnetic field generated by the core and coil 24 attracts the ring 18 so as to urge it to bridge the air gap 20 in a centralised manner. However, the valve 4 is so designed that the bearing of the head 14 on the seat 6 prevents the ring 18 from centering perfectly relative to the air gap 20, thus providing the closing force on the member 10. The member 10 remains closed for as long as the electromagnetic field is maintained at an appropriate strength, or until the member 10 is exposed to a downward force greater than the upward closing force produced by the electromagnetic field. Such downward, opening force will usually be produced by flow of product to be filled into containers and this product flow is generated by a filler pump. When product flow ceases, the member 10 will return to its closed position under the upward force produced thereon by the electromagnetic field.

The valve device described with reference to FIG. 1 has a number of advantages. One advantage is that there are no moving parts other than the valve obturating member 10 itself and thus there is less wear and tear than if the closing force were to be produced by a mechanical spring. Moreover, the closing force is easily adjustable by adjustment of the magnitude of the current supplied via the leads 26. Such easy adjustment of the magnitude of the current through the coil can be very beneficial in applications where it is desired to reduce stress (particularly shear) on stress-sensitive products. In particular, by appropriate adjustment of the magnitude of the current, it is possible to achieve an open position of the member 10 which is, for the liquid in question, an appropriate compromise between laterally outward expulsion and almost vertically downward expulsion. Furthermore, the magnitude of the closing force is dependent upon the electromagnetic field and the distance between the air gap 20 and the guiding ring 18, i.e. the greater that distance the lower the closing force. This feature is particularly useful in applications where an inverse progressive force (which is the opposite of what is obtained with a mechanical spring) is required or at least beneficial.

Referring to FIG. 2, the valve device includes a plurality of inductors in the form of electromagnetic coils 32 stacked co-axially on top of each other to create a corresponding plurality of magnetic fields. It is thereby possible to control the position of the valve closure member 10 independently of a constant product pressure by increasing or decreasing independently of each other the strengths of the respective magnetic fields. In other words, the coils 32 are arranged to form a linear motor, which enables control of the position of the member 10. For that purpose, there is incorporated a linear encoder to determine the actual position of the valve closure member 10, so that the currents supplied to the individual coils 32 can be controlled accordingly.

Another advantage of the version described with reference to FIG. 2 is that the stroke of the valve closure member 10 can be extended without loss of control of the movement of that member in more remote positions of reduced obturation by the member.

Generally, the invention has the advantages of enabling the valve device to be particularly hygienic (since no access is required through the wall of the tube 2), to be relatively inexpensive, and to be flexible in application, and of being usable for a wide field of applications (for example, the invention is readily applicable to the valve device disclosed in EP-A-90664)

1-12. (canceled)

13. A valve device for controlling fluid flow, comprising
a hollow body bounding a flow path for the fluid through said valve device,
a valve obturating member in said flow path and movable between a more obturating position and a less obturating position for permitting lesser and greater flows of said fluid along said path, which flows urge said member in the sense from said more obturating position to said less obturating position, said valve obturating member including magnetic portions,
an electrically energizable inductor which, while remaining stationary relative to said body and while electrically energized, acts upon said valve obturating member with a force to urge said valve obturating member in the sense from said less obturating position to said more obturating position,
an electrical supply arrangement connected to said inductor, and
a control arrangement which is connected to said electrical supply arrangement and which serves to adjust the magnitude of the current supplied to said inductor by said supply arrangement and thereby to adjust said force.

14. A valve device according to claim 13 and having no moving parts other than said valve obturating member.

15. A valve device according to claim 13, and further comprising a valve seat on said flow-path, said more obturating position being an end position in which said valve obturating member is fully closed on the valve seat, so as to be applied to the seat in a substantially fluid-tight manner, and said valve seat facing downstream of said flow path, whereby said less obturating position is further downstream in said flow path than is said more obturating position.

16. A valve device according to claim 13, wherein there are a plurality of electrically energizable inductors, including said inductor, which, while remaining stationary relative to said body and while electrically energized, act to urge said valve obturating member in said sense, and which are connected to said electrical supply arrangement, said control arrangement serving to control the currents supplied to the respective inductors by said supply arrangements, and said inductors constituting a linear motor.

17. A valve device according to claim 16 and further comprising a linear encoder which is connected to said control arrangement and whereby the position of said valve obturating member along said flow path is determinable.

18. In a filler of a machine the output of which is filled containers, a valve device according to claim 13.

19. A method of controlling fluid flow, comprising producing fluid flow along a flow path in a direction such that said fluid flow urges a valve obturating member in a sense from a more obturating position to a less obturating position, electrically energizing an inductor, while said inductor remains stationary, to cause said inductor to act inductively upon said valve obturating member with a force to urge said valve obturating member in the sense from said less obturating position to said more obturating position, and varying the electrical current supplied to said inductor to adjust said force.

20. A method according to claim 19, wherein said more obturating position is an end position in which said valve obturating member prevents flow of said fluid past said valve obturating member, less obturating position being further downstream in said flow path than is said more obturating position.

21. A method according to claim 19, and including electrically energizing a plurality of inductors, including said inductor, while said inductors remain stationary, to cause said inductors to act upon said valve obturating member to urge said valve obturating member in the sense from said less obturating position to said more obturating position.

22. A method according to claim 21, and further comprising determining the position of said valve obturating member along said flow path and controlling current supply to the individual inductors accordingly.

23. A method according to claim 19, and further comprising filling with the fluid a container downstream of said valve obturating member.
